(19) United States
(12) Patent Application Publication
(10) Pub. No.: US 2003/0038506 A1
(43) Pub. Date: Feb. 27, 2003

(54) Outside mirror structure for vehicle

(76) Inventor: Wee Duck Jang, Seoul (KR)

Correspondence Address: Wee Duck, 415-13 Ku Ro Bon-Dong, Ku Ro-Ku, Seoul, KR

(21) Appl. No.: 09/939,188

(22) Filed: Aug. 23, 2001

(51) Int. Cl. H05B 3/84

(52) U.S. Cl. 296/180.1

(57) ABSTRACT

The present invention discloses an outside mirror structure for a vehicle which can rapidly remove raindrops from an outside mirror by an air current induced to an upper portion of a casing of the outside mirror through an air duct. The outside mirror structure includes the casing consisting of the mirror, the air duct for guiding a wind current to the front surface of the mirror by covering the upper portion of the casing, and interception films for preventing raindrops or foreign substances from entering the upper portion of the casing.

### BACKGROUND OF THE INVENTION

1. Field of the Invention

The present invention relates to an outside mirror structure, and in particular to an improved outside mirror structure for a vehicle which can rapidly remove raindrops from an outside mirror by an air current induced to an upper portion of a casing of the outside mirror through an air duct.

2. Description of the Related Art

In general, a driver obtains a rear field of vision through an outside mirror in driving a vehicle. When raindrops are formed on the outside mirror, the driver can not obtain the rear field of vision, and thus has trouble in changing a lane.

Especially, a rudimentary driver has more difficulty in driving a vehicle. Thus, drivers should pull down a door glass and wipe it with a duster.

A conventional outside mirror structure for a vehicle has been disclosed in Japanese Patent Publication Gazette 60-8446 (Application date: Sep. 29, 1983). As described therein, when the mirror is installed in a casing fixed to a body of the vehicle, a slit is provided to form an air passage between the main body and the mirror.

In the conventional outside mirror structure, the air flowing through the main body of the vehicle is passed through the slit, and a small eddy current formed between an air current passed through the slit and an air current passed through the side portion of the casing is rotated in a predetermined direction, to remove water drops from the mirror.

However, the small eddy is generated on the front surface of the mirror due to the surrounding air current. It is thus difficult to rapidly efficiently remove water drops from the mirror. In addition, water drops are wiped to the side portion of the mirror, and thus are not completely removed.

### SUMMARY OF THE INVENTION

It is, therefore, an object of the present invention to provide an outside mirror structure for a vehicle which can rapidly remove water drops from a mirror, so that a driver can obtain a rear field of vision in driving the vehicle in a rainy day.

To achieve the above object, there is provided an outside mirror structure for a vehicle including a casing consisting of a mirror, an air duct for guiding a wind current to the front surface of the mirror by covering the upper portion of the casing, and interception films for preventing raindrops or foreign substances from entering the upper portion of the casing.

### BRIEF DESCRIPTION OF THE DRAWINGS

The above objects, features and advantages of the present invention will become more apparent from the following detailed description when taken in conjunction with the accompanying drawings, in which:

FIG. 1 is a perspective view illustrating an outside mirror structure for a vehicle according to the present invention; and

FIG. 2 is a cross-sectional view illustrating the outside mirror structure, taken along line A-A in FIG. 1.

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description such as a detailed construction and elements of a circuit are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

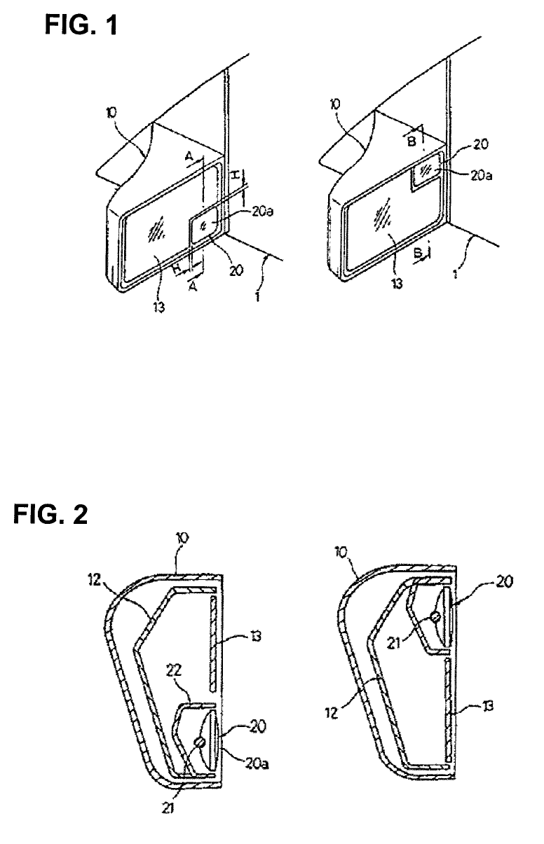

Referring to FIGS. 1 and 2, an air duct 20 for guiding a wind current to the front surface of a mirror M is formed in a casing 10 having the mirror M. The air duct 20 consists of a wide space unit 21 and a narrow space unit 22, and has its end portion 23 slanted toward the mirror M.

In addition, interception films 30, 31 for preventing raindrops or foreign substances from entering the air duct with air are protruded from the upper portion of the casing 10, so that only air can pass an outlet 20a of the air duct 20.

A heater 40 is provided to the upper portion of the casing 10, for generating hot blast in the air duct 20. Here, the heater 40 is connected to a power supply source of the vehicle.

As illustrated in FIG. 2, when a driver drives a vehicle in a rainy day, the air collides with the mirror M through a passage of the air duct 20. Here, the air increased in the wide space unit 21 has a rapid flow rate in the narrow space unit 22. The air current directly collides with the mirror M, thus easily falling raindrops from the mirror M.

On the other hand, raindrops or foreign substances are intercepted by the interception films 30, 31 not to pass the air duct 20.

When the heater 40 is operated, hot blast generated in the air duct 20 collides with the mirror M, to efficiently remove raindrops.

In accordance with the present invention, when a driver drives a vehicle in a rainy day, raindrops are rapidly removed from the outside mirror, so that the driver can obtain a rear field of vision and safely change a lane.

While the invention has been shown and described with reference to certain preferred embodiment thereof, it will be understood by those skilled in the art that various changes in form and details may be made therein without departing from the spirit and scope of the invention as defined by the appended claims.

What is claimed is:

1. An outside mirror structure for a vehicle comprising:
a casing including a mirror and an air duct, the air duct being provided with interception films for intercepting foreign substances and a heater.

2. The structure according to claim 1, wherein the heater increases a temperature of air flowing to the air duct.
